(19) United States
(12) Patent Application Publication
(10) Pub. No.: US 2003/0000401 A1
(43) Pub. Date: Jan. 2, 2003

(54) Inking device

(76) Inventor: Peter Maier, Worms (DE)

Correspondence Address: Douglas R Hanscom, Jones Tullar & Cooper, Eads Station, PO Box 2266, Arlington, VA, 22202, US

(21) Appl. No.: 10/169,094

(22) PCT Filed: Dec. 2, 2000
(86) PCT No.: PCT/DE00/04292

(30) Foreign Application Priority Data
Jan. 18, 2000 (DE) 100 01 764.9

(51) Int. Cl. B41F 31/00

(52) U.S. Cl. 101/350.5

(57) ABSTRACT

The invention relates to an inking device for inking a cylinder or a printing cylinder (33) of an intaglio printing inking unit. A doctor blade device (23) is located in the vicinity of the ink level (34) of the printing ink. By heating the ink duct, the doctor blade device and the cylinder to be inked, it is possible to print solvent-free printing inks at temperatures in the range of 100° C.

### FIELD OF THE INVENTION

The present invention is directed [relates] to an ink application device for a rotary printing press [in accordance with the preamble of claim 1]. The printing ink and at least a portion of the doctor blade arrangement are heated.

### BACKGROUND OF THE INVENTION

A rotogravure inking device has become known from EP 655 328 B1. A[, whose] doctor device is arranged remote from the ink duct and closely in front of the printing zone in order to prevent the premature drying of the solvent-containing printing ink.

DE 93 10 680 U1 describes an arrangement for setting the temperature of printing ink in the inking device of a printing press. No doctor device resting against a roller is provided there.

WO 98/50233 A shows a rotogravure inking device. A[, wherein a] doctor blade is arranged below a horizontal line extending through the axis of rotation of the forme cylinder.

DE 197 36 339 A1 describes a temperature-adjusting device for a screen roller with a doctor blade.

DE 42 05 713 C2 discloses rotogravure ink, which is used for printing in a warmed state and which dries by cooling.

### SUMMARY OF THE INVENTION

The object of the present invention is directed to providing [based on creating] an ink application device for a forme cylinder used with rotogravure printing. Printing[, by means of which printing] inks, whose working temperatures lie [temperature lies] above the ambient, temperature can be used for printing.

In accordance with the present invention, this object is attained by providing printing ink in an ink trough of an ink application device for rotogravure printing on a rotary printing press. The printing ink in the ink trough has a working temperature higher than ambient. At least parts of a doctor blade arrangement in the ink application device are capable of being heated. A contact line of a doctor blade of the doctor blade arrangement is below a horizontal line that extends through the axis of rotation of a forme cylinder in the rotary printing press [the characteristics of claim 1].

The advantages which can be obtained by [means of] the present invention rest, in particular, in that [the] removal of the printing ink from the roller, or from the forme cylinder, by use [means] of a doctor blade, takes place in the immediate vicinity of the ink level of the printing ink in the ink trough. This results in a short distance [height to fall] for the printing ink, removed by [means of] a doctor blade from the roller to be inked, to fall. In this way, faults because of splashes when the removed ink drops into the ink duct, are held to a minimum. An [and an] ink foam, which would otherwise be created, is also prevented, so that soiling of the inking device does not occur.

Because of the ability to preset the temperature of the printing ink, it is possible to also use so-called hot-tec printing inks for rotogravure printing. In this context, [—] see DE 42 05 713 C2. These printing inks [—which] are applied without solvents at a temperature of approximately 100 to 110° C. to the material to be printed.

Only a negligible heat loss is noted because of a compact arrangement of the parts of the inking device which come into contact with the hot-tec printing ink.

### BRIEF DESCRIPTION OF THE DRAWINGS

A preferred [An exemplary] embodiment of the present invention is represented in the drawings and will be described in greater detail in what follows.

Shown are in:

FIG. 1, a cross sectional view [section] through an ink application device in accordance with the present invention in a [the] position of rest, and in

FIG. 2, a top plan view of [from above on] the ink application device in accordance with FIG. 1 in a partial representation and without a forme cylinder.

### DESCRIPTION OF THE PREFERRED EMBODIMENT

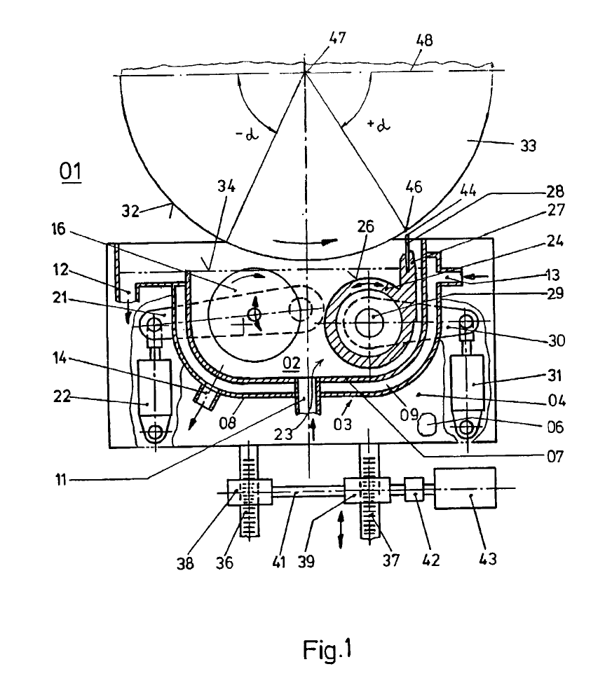

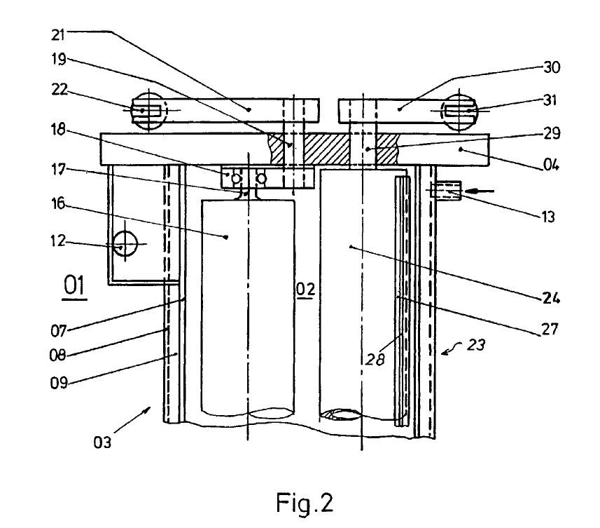

An ink application device 01 [for printing ink 02] of an ink unit of a rotary printing press consists of an ink trough 03 containing printing ink 02, which ink trough 03 is fastened at both ends on end plates 04, 06, which end plates 04, 06 are fixed in place in lateral frames of a rotary printing press, all as seen in FIGS. 1 and 2. The ink trough 03 preferably [usefully] consists of a double-walled container, i.e. of an inner and outer container 07, 08, between which is defined a hollow space 09 for receiving a heatable [warmable] fluid, for example warmth-distributing oil[, is provided].

The inner container 07 is provided with an ink inlet line 11 and with an ink outlet line [11,] 12. The[, and the] outer container 08 is provided with a warming fluid inlet line 13, as well as a warming fluid outlet line [13,] 14. The ink level is maintained constant in the ink trough 03 by [means of] the placement of the ink outlet line 12 at a defined height.

An ink application device, for example an inking roller 16, is located inside the ink trough 03, and is supported [seated] at both ends on pivotable inner levers 18. as seen in FIG. 2. In turn, the pivotable inner levers 18 are each fastened, fixed against relative rotation, on a lever shaft 19 which is passed through the end plates 04, 06. Outside of the end plates 04, 06, each lever [the] shaft 19 is connected, fixed against relative rotation, with a respective outer lever[s] 21, each of which outer levers 21 can be pivoted into a position of rest, as depicted in [(]FIG. 1 [)], or into an operating position, not specifically represented, by utilization [means] of a work cylinder 22, as shown in both FIGS. 1 and 2.

A doctor blade arrangement, shown generally at 23, is also arranged in the ink trough 03. Doctor blade arrangement 23[,] consists, for example, of a cylindrical doctor blade support 24, which has a clamping strip 27 extending in the tangential direction in respect to a [the] surface area 26 of the doctor blade support 24, as well as in an axis-parallel direction. A[, in which a] doctor blade 28 made, for example, of spring steel, is maintained in the doctor blade support 24 by the clamping strip 27. The clamping strip 27 is fixedly arranged on the doctor blade support 24.

[By means of its journals 29 conducted through the end plates 04, 06, the] The doctor blade support 24 has journals 29 that extend through the end plates 04, 06. Each such journal 29 is connected outside of the end plates 04, 06, fixed against relative rotation, with a piston rod of a work cylinder 31 by [mean of] a lever arm 30. When the work cylinder 31 is actuated, the doctor blade support 24 rotates, so that the doctor blade 28 can be placed against a [the] surface area 32 of a roller to be inked, for example the surface area 32 of a forme cylinder 33 for rotogravure printing, or a screen roller which is provided with surface area depressions. The roller, or the forme cylinder 33 is embodied so it can be warmed, at least on its surface area.

With [In] respect to the roller, or the forme cylinder 33, the doctor blade arrangement 23 is arranged in such a way that a contact line 46, defined [created] by a line of contact between a [means of the] working edge 44 of the doctor blade 28, which is in the working position, and the surface 32 of the roller or cylinder 33 to be inked extends on the surface area 32 [26] of the forme cylinder 33 below a horizontal line 48 extending through an [the] axis of rotation 47 of the forme cylinder 33. Contact line 46 is situated within an angular range α of between 40° and 70°, preferably in a range −+α of 50° to 60°, and in particular at an angle α of 55°, in respect to the horizontal line 48.

[An ink level 34 in the] The ink trough 03 is dimensioned in such a way that an ink level 34 is maintained in the ink trough 03 so that in their position of rest, the inking roller 16, as well as the doctor blade arrangement 23, are almost completely covered by printing ink 03. The clamping strip 27 is at least partially bathed in printing ink.

Each of the end plates 04, 06 are interlockingly connected with separate toothed racks 36, 37, as seen in FIG. 1. The toothed racks 36, 37 are displaceably seated in guide elements 38, 39 fixed in place in the lateral frames. Pinion gears are arranged on a driveshaft 41 and are in engagement with the teeth of the toothed racks 36, 37.

The driveshaft 41 is connected via, a coupling 42, with a step motor 43, which is seated, fixed in place, in the lateral frames. A counting device, not specifically represented, is used as the indicator of the actual height setting of the ink trough 03 in relation to the forme cylinder 33. The roller, or the forme cylinder 33 can be exchanged and can thus have diameters of different sizes.

In accordance with a [an embodiment] variation of the preferred embodiment, it is possible to heat the doctor blade 28 separately. This [For example, this] can be accomplished, for example, in that the doctor blade holder 27 can be [is] embodied so that it can be heated, for example electrically [heated], near the clamped portion of the doctor blade 28.

For the separate heating of the doctor blade 28, it is also [furthermore] possible to arrange an induction coil located on the rim of the inner container 07 and extending in an axis-parallel direction.

In the rotogravure printing process, it is possible to arrange a counter-cylinder, which is not specifically represented, and which acts against the forme cylinder 33. The assumed direction of rotation of the forme cylinder 33 is [runs] counterclockwise, as depicted in FIG. 1. The rotation direction can also be [in a] clockwise [direction]. However, for this direction of rotation it would be necessary to exchange the lateral arrangement of the inking roller 16, as well as of the doctor blade arrangement.

The ink application device in accordance with the present invention operates as follows: the ink trough 03 is vertically displaced [by actuating means 36 to 39 and 43] in the direction toward the forme cylinder 33 and is matched to the diameter of the latter. This displacement of the ink trough 03 is accomplished by actuation of the step motor 43, the pinion gears and the toothed racks 36 and 37, as discussed above. Preheated printing ink 02, in the approximate temperature range between 60° C. to 180° C., and preferably between 100° C. and 110° C., is filled into the inner container 07 of ink trough 03. The hollow space 09 located between the inner and outer containers 07, 08 is filled with heated [warmed] warming oil of a similar [an analog] temperature.

The warming oil can be heated or warmed outside of, as well as inside of the hollow space 09.

The inking roller 16, as well as the doctor blade 28, can now be placed against the surface area 32 of the forme cylinder 33 while in the working position.

Following the termination of the printing process the printing ink 02 remains warmed until the start of the next printing process.

It is, of course, also possible to work with solvent-containing printing ink.

While a preferred embodiment of an inking device in accordance with the present invention has been set forth fully and completely hereinabove, it will be apparent to one of skill in the art that various changes in, for example the drive for the forme cylinder, the source of heat for the ink warming fluid and the like could be made without departing from the spirit and scope of the present invention which is to be limited only by the following claims.

### [LIST OF REFERENCE NUMBERS

01 Ink application device

02 Printing ink

03 Ink trough

04 End plate (01)

05—

06 End plate (01)

07 Container, inner (03)

08 Container, outer (03)

09 Hollow space (07, 08)

10—

11 Ink inlet line

12 Ink outlet line

13 Warming fluid inlet line

14 Warming fluid outlet line

15—]

[16 Inking roller

17 Journal (16)

18 Lever(16)

19 Shaft (04, 06)

20—

21 Lever (16)

22 Work cylinder (16)

23 Doctor blade arrangement

24 Doctor blade support (23)

25—

26 Surface area (24)

27 Clamping strip (28)

28 Doctor blade (23)

29 Journal (24)

30 Lever arm (29)

31 Work cylinder (23)]

[32 Surface area (33)

33 Forme cylinder, roller

34 Ink level (02)

35—

36 Toothed rack

37 Toothed rack

38 Guide element (36)

39 Guide element (37)

40—

41 Driveshaft

42 Coupling

43 Step motor

44 Working edge (28)

45—

46 Contact line (44, 33)

47 Axis of rotation]

[48 Horizontal line (47)

+α angle (48, 47)

−α angle (48, 47)]

1. An ink application device for printing ink (2) on a forme cylinder (33) for rotogravure printing on a rotary printing press, having an ink trough (03) and a doctor blade arrangement (23) set against the forme cylinder (33), wherein the printing ink in the ink trough (03) has a working temperature which is higher than the ambient temperature, characterized in that at least parts (24, 27) of the doctor blade arrangement (23) are embodied so that they can be heated, and that a contact line (46) of a doctor blade (26) of the doctor blade arrangement (23) extends below a horizontal line which extends through the axis of rotation (47) of the forme cylinder (33).

2. The ink application roller in accordance with claim 1, characterized in that the doctor blade arrangement (23) consists of a rotatable doctor blade support (24) and of a clamping strip (27), fixedly arranged on the latter for clamping a doctor blade (28) in place.

3. The ink application roller in accordance with claim 2, characterized in that the surface of the doctor blade support (24) is located in its entirety, and the surface of the clamping strip (27) is located at least partially, below a preset ink level (34) on the printing ink (02) in the ink trough (03).

4. The ink application roller in accordance with claims 1 and 3, characterized in that the ink trough (03) is embodied as a double-walled container (07, 08).

5. The ink application roller in accordance with claim 4, characterized in that a hollow space (09) located between the containers (07, 08) can be filled with a fluid which can be warmed.

6. The ink application roller in accordance with claims 1 and 3, characterized in that the ink level (34) of the printing ink (02) is maintained constant by the arrangement of an ink inlet line (11) and of an ink outlet line (12), which is arranged at the height of the ink level (34).

7. The ink application roller in accordance with claims 1 and 2, characterized in that at least the doctor blade (28) of the doctor blade support (24) is embodied so that it can be heated by means of a separate heater.

8. The ink application roller in accordance with claim 7, characterized in that the heater is embodied as an induction heater.

9. The ink application roller in accordance with claim 1, characterized in that the roller (33) can be warmed at least on its surface area (32).

10. The ink application roller in accordance with claim 1, characterized in that the contact line (46) of the doctor blade (28) on the forme cylinder (33) extends at an angular range +−α of 50° to 60° in respect to a horizontal line.

11. The ink application roller in accordance with claim 1, characterized in that the forme cylinder (33) can be warmed at least on its surface area (32).

12. The ink application roller in accordance with claim 1, characterized in that the application device (16) has an inking roller (16).

13. The ink application roller in accordance with claim 1, characterized in that the doctor blade (28) is embodied so that it can be placed against the roller (33) by actuating members (29, 30, 31).

14. The ink application roller in accordance with claim 12, characterized in that the ink roller (16) is embodied so that it can be placed against the roller (33) by actuating members (18, 19, 21, 22).

15. The ink application roller in accordance with claim 1, characterized in that at least portions of the doctor blade arrangement (23) are bathed in the preheated printing ink.

16. The ink application roller in accordance with claim 1, characterized in that the printing ink (02) in the ink trough (03) has a working temperature of 60° to 180°.
